(19) United States
(12) Patent Application Publication
(10) Pub. No.: US 2009/0299827 A1
(43) Pub. Date: Dec. 3, 2009

(54) Verifying Operator Competence

(75) Inventors: Srinivasulu Puri, Irvington, NY (US); Srikanth Karimisetty, Austin, TX (US); Savita Durgada, Irvington, NY (US); Pawan Kumar, Yorktown Heights, NY (US); Susruth Doddapaneni, Andhra Pradesh (IN)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/130,037

(22) Filed: May 30, 2008

(51) Int. Cl. G06Q 10/00

(52) U.S. Cl. 705/11

(57) ABSTRACT

Systems and methods are disclosed herein for verifying the competence of an operator in a manufacturing facility. In one implementation, for example, an operator competence verifying system comprises one or more input/output (“I/O”) devices configured to receive information from a user and provide information to the user. The system also comprises a processing device, which is configured to enable the user to set up a competence profile of an operator in the manufacturing facility. The processing device is further configured to enable the user to define jobs related to handling sensitive material at multiple material handling stages in the manufacturing facility. Also, the processing device is configured to assign training to the operator as needed to meet industry guidelines. The processing device is also configured to enable the user to define competence levels required at each multiple material handling stage.

### TECHNICAL FIELD

The embodiments of the present disclosure generally relate to handling sensitive materials and products during manufacture. More particularly, the embodiments herein relate to verifying the competence of operators at various stages of the manufacturing process.

### BACKGROUND

The Food and Drug Administration (“FDA”) regulates, among other things, good manufacturing practices for pharmaceutical companies. For example, guidelines for personnel qualifications are defined in 21 CFR §211.25, whereby “each person engaged in the manufacture, processing, packing, or holding of a drug product shall have education, training, and experience, or any combination thereof, to enable that person to perform the assigned functions.” The assigned functions are to be performed “in such a manner as to provide assurance that the drug product has the safety, identity, strength, quality, and purity that it purports or is represented to possess.” In regulated industries such as pharmaceuticals and food, it is important to enforce competence and certification checks throughout the manufacturing process.

According to quality standards of the International Organization for Standardization (“ISO”) and FDA regulations, companies are required to execute and document employee training. These requirements ensure employees understand their duties within the company and are familiar with the industry guidelines. Well-managed training programs minimize the risk of noncompliance and improve product quality.

In the manufacturing of pharmaceuticals, a manufacturing run is identified as a batch in which various operations are executed on the batch at various stages. At each stage, certification/competence requirements are monitored to ensure that FDA regulations are being adhered to. Some of the various stages of manufacture may include, for example, material consumption recording, material yield recording, resource usage recording, quality sample collection, quality results, process parameters recording, material dispensing, etc.

### SUMMARY

The present disclosure describes systems, methods, and associated software for verifying the competence of an operator in a manufacturing facility. In one embodiment, among many, a system for verifying operator competence includes one or more input/output devices, which are configured to receive information from a user and provide information to the user. The system also includes a processing device, which is configured to enable the user to set up a competence profile of an operator in the manufacturing facility. The processing device is also configured to enable the user to define jobs related to handling sensitive material at multiple material handling stages in the manufacturing facility. In addition, the processing is configured to assign training to the operator as needed to meet industry guidelines and enable the user to define competence levels required at each multiple material handling stage.

Other features, advantages, and implementations of the present disclosure, not expressly disclosed herein, will be apparent to one of ordinary skill in the art upon examination of the following detailed description and accompanying drawings. It is intended that such implied implementations of the present disclosure be included herein.

### BRIEF DESCRIPTION OF THE DRAWINGS

The components of the following figures are illustrated to emphasize the general principles of the present disclosure and are not necessarily drawn to scale. Reference characters designating corresponding components are repeated as necessary throughout the figures for the sake of consistency and clarity.

FIG. 1 is a block diagram of a competence verification system, according to one embodiment.

FIG. 2 is a block diagram of the operator competence verification program shown in FIG. 1, according to one embodiment.

FIG. 3 is a graphical user interface (GUI) for registering an employee, according to one embodiment.

FIG. 4 is a GUI for initiating a competence profile of an employee, according to one embodiment.

FIG. 5 is a GUI for entering competence information of an employee, according to one embodiment.

FIG. 6 is a GUI for defining a job, according to one embodiment.

FIG. 7 is a GUI for defining a position, according to one embodiment.

FIG. 8 is a GUI for defining competencies, according to one embodiment.

FIG. 9 is a GUI for defining competence requirements, according to one embodiment.

FIG. 10 is a GUI for managing education and training information, according to one embodiment.

FIG. 11 is a GUI for defining an education and training path, according to one embodiment.

FIG. 12 is a GUI for defining the competencies achieved by specific education and training, according to one embodiment.

FIG. 13 is a GUI for cataloging certification information, according to one embodiment.

FIG. 14 is a GUI for setting up certification and competence requirements for a transaction, item, or resource handling, according to one embodiment.

FIG. 15 is a GUI for logging in to request an override, according to one embodiment.

FIG. 16 is a GUI for presenting a user disqualification error, according to one embodiment.

### DETAILED DESCRIPTION

In a conventional manufacturing plant, the manufacturing process is carried out in various stages and typically a paper document accompanies a product batch during manufacture, where the document can contain manual checks along the process. For example, when a batch is initiated on the manufacturing shop floor, a supervisor identifies the operators who can work on portions of the manufacturing process based on their certification and competence.

However, according to the embodiments described herein, the present disclosure defines automated systems and methods for verifying operator certification in a manufacturing process. In order for manufacturing to pass on to the next stage, automated certification and competence checks are required. Although examples of manufacturing are described herein, the present disclosure also applies to any various types of competence checks in which sensitive matter is handled at various stages along a process. In particular, the material, objects, substances, products, etc., handled by the operators at the various stages can include any sensitive material, products, byproducts, precious materials, hazardous materials, or other matter or product that requires special handling. Although many of the examples described in the present disclosure pertain to the handling of pharmaceuticals, it should be noted that the embodiments discussed herein can apply to any type of sensitive material.

Prior to the manufacturing process, an administrator can set up competence and certification requirements for the various stages along the material handling process. With a valid set up, certification and competence requirements can be enforced throughout the manufacturing process to ensure that operators handling the products are properly authorized. The administrator can also specify whether an override of the operator competence requirements can be allowed, where such an override allows bypassing one or more checkpoints when the current operator does not have valid certification or credentials to perform the task. This override can be performed when the person giving an override has the required competence or certifications to perform the task.

The automated methods described herein provide strict enforcement of certification and competence requirements based on up to date information in the system. This will eliminate human error or communication issues that can occur in a manual system. For example, if a production process is started and operators are identified, it is possible that certification requirements can change. In conventional manufacturing processes, even though a supervisor should revalidate assignments and communicate new policies to the operators, some processes might still complete without enforcing the new requirements. With the systems described herein, an automated verification of operator competence will automatically stop the operator from proceeding with an unauthorized transaction. Furthermore, this solution can provide a more stringent implementation of regulatory requirements.

With the automated operator certification system in place in the manufacturing process, an administrative user can define or set up multiple competence and certification requirements at various levels of material handling. Also, the operator certification system allows the administrative user to enable override ability at various stages where appropriate. With such an automated system, a record of the process manufacturing stages can be stored electronically and a report presented to management. Administrators can easily adopt and enforce new competence and certification checks throughout the manufacturing process, allowing manufacturing companies to enforce certification requirements uniformly across multiple plants. Management and/or auditors can easily review a log or record of the multiple certification stages and see any overrides that have been made during the process.

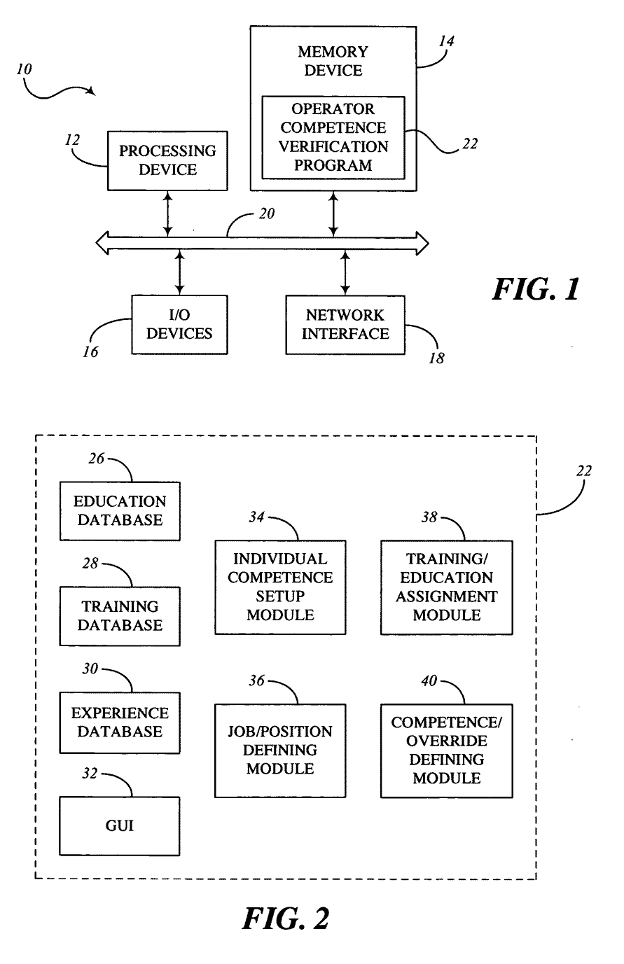

FIG. 1 is a block diagram illustrating an embodiment of a competence verification system 10. Competence verification system 10 may comprise a computer or other suitable information processing system allowing a user to transmit and receive data, information, and instructions within networks of an organization. Furthermore, competence verification system 10 may be replicated at multiple locations along a manufacturing line. In some embodiments, portions of competence verification system 10 may be located in remote areas throughout a manufacturing plant, depending on the desired configuration. Competence verification system 10 may be configured to allow entry of competence profiles of operators who handle sensitive materials during manufacture. Competence verification system 10 can also determine whether the operators who handle the sensitive materials are properly authorized to perform certain tasks or functions at respective stages. Also, competence verification system 10 can assign classes or courses for updating the operators' educational or training credentials as necessary.

In the embodiment of FIG. 1, competence verification system 10 comprises a processing device 12, a memory device 14, input/output (“I/O”) devices 16, and network interface 18. The components of competence verification system 10 are interconnected with each other via a bus 20. Processing device 12 may be a general-purpose or specific-purpose processor or microcontroller. Memory device 14 may include any suitable type of storage components and, according to this and other embodiments, includes an operator competence verification program 22 stored therein, as described in more detail below.

Memory device 14 may include one or more internally fixed storage units, removable storage units, and/or remotely accessible storage units. The storage units can be configured to store information, data, instructions, and/or software code. The storage units may include any combination of volatile memory, such as random access memory (“RAM”), dynamic RAM (“DRAM”), etc., and/or non-volatile memory, such as read only memory (“ROM”), electrically erasable programmable ROM (“EEPROM”), flash memory, etc.

Operator competence verification program 22 stored in memory device 14 can be executed by processing device 12. Various logical instructions or commands may be included in operator competence verification program 22 for setting up competence profiles for different operators. Operator competence verification program 22 can also maintain and assign training/education information for operators to determine when additional training may be needed. In addition, operator competence verification program 22 can define the competence requirements at various stages of the manufacturing process and even establish conditions in which these competence requirements can be overridden. Furthermore, operator competence verification program 22 can log or record information regarding the verification process at the various stages and whether an override has been requested and/or granted. A report of the verification log can be presented to management in order that management can monitor the manufacturing process to ensure compliance to applicable guidelines and rules.

The embodiments of operator competence verification program 22 described in the present disclosure can be implemented in hardware, software, firmware, or a combination thereof. When implemented in software or firmware, operator competence verification program 22 is stored in memory device 14 and executed by processing device 12. Alternatively, when implemented in hardware, operator competence verification program can be implemented in processing device 12 using discrete logic circuitry, an application specific integrated circuit (“ASIC”), a programmable gate array (“PGA”), a field programmable gate array (“FPGA”), or any combination thereof.

Operator competence verification program 22 or other software or logic code including executable logical instructions as described herein, can be embodied in computer-readable media for execution by any suitable processing device, such as processing device 12. The computer-readable media as described herein can include one or more suitable physical media components that can store the software, programs, or computer code for a measurable length of time.

I/O devices 16 may include input mechanisms such as keyboards, keypads, cursor control devices, or other data entry devices. The input mechanisms may be used for entering information in memory device 14. For example, to define override information at a particular stage of manufacture, a user can enter the information using any suitable input mechanisms. I/O devices 16 also include output devices such as computer monitors, audio output devices, printers, or other peripheral devices for communicating information to the user. Another example of an output device may include a display screen or report printing mechanism for communicating verification checks and overrides to management.

Network interface 18 allows competence verification system 10 to communicate with other devices via any type of network associated with the corporation, enterprise, or manufacturing facility. For example, competence verification system 10 may be in communication with an enterprise resource planning (“ERP”) system or other type of integrated system of the corporation.

FIG. 2 is a block diagram of an embodiment of the operator competence verification program 22 shown in FIG. 1. In this embodiment, operator competence verification program 22 includes an education database 26, training database 28, experience database 30, graphical user interface (GUI) 32, individual competence setup module 34, job/position defining module 36, training/education assignment module 38, and competence/override defining module 40. The databases 26, 28, and 30 may include one or more storage mechanisms as needed and are configured to store updated information about each employee's or operator's education, training, and experience in a variety of different jobs or positions related to the respective manufacturing process or sensitive material handling process. In some embodiments, databases 26, 28, and 30 may be centrally stored in a common database associated with a corporation's ERP system or other integrated network system.

Individual competence setup module 34 uses the updated information in databases 26, 28, and 30 to determine and establish each individual operator's competence. Therefore, in this respect, competence can be considered to be a combination of an operator's education, training, and experience, which, according to 21 CFR §211.25, is a measure of a person's credentials for performing assigned functions in the manufacturing process.

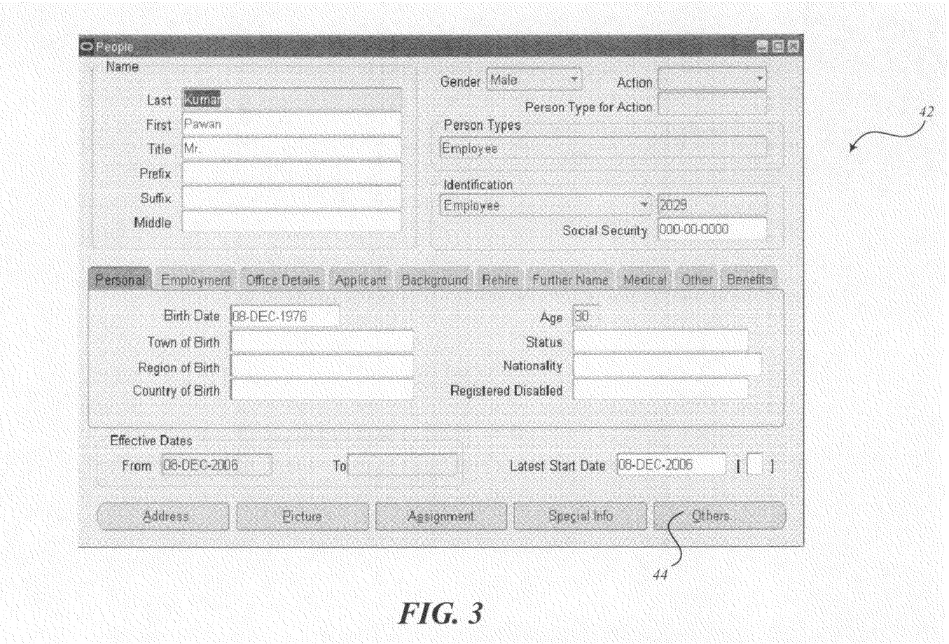

GUI 32 may include any combination or number of user interfaces, communicated via I/O devices 16, for receiving information from a user and presenting information to the user. As discussed in more detail below, some user interfaces can be used for set up with respect to individual competence setup module 34. Some interfaces can be used for defining jobs and positions with respect to job/position defining module 36, some can be used for assigning training and education with respect to training/education assignment module 38, and some for defining competence levels and overrides with respect to competence/override defining module 40. GUI 32 may represent or include multiple graphical user interfaces as described with respect to FIGS. 3-16, which may be associated with a centralized or integrated data system, such as an ERP system, associated with an organization. Although the following description of GUIs typically includes one option for advancing to another window or screen, it should be recognized that one or more options or selections can be used to navigate the different GUIs as will be understood by one of ordinary skill in the art.

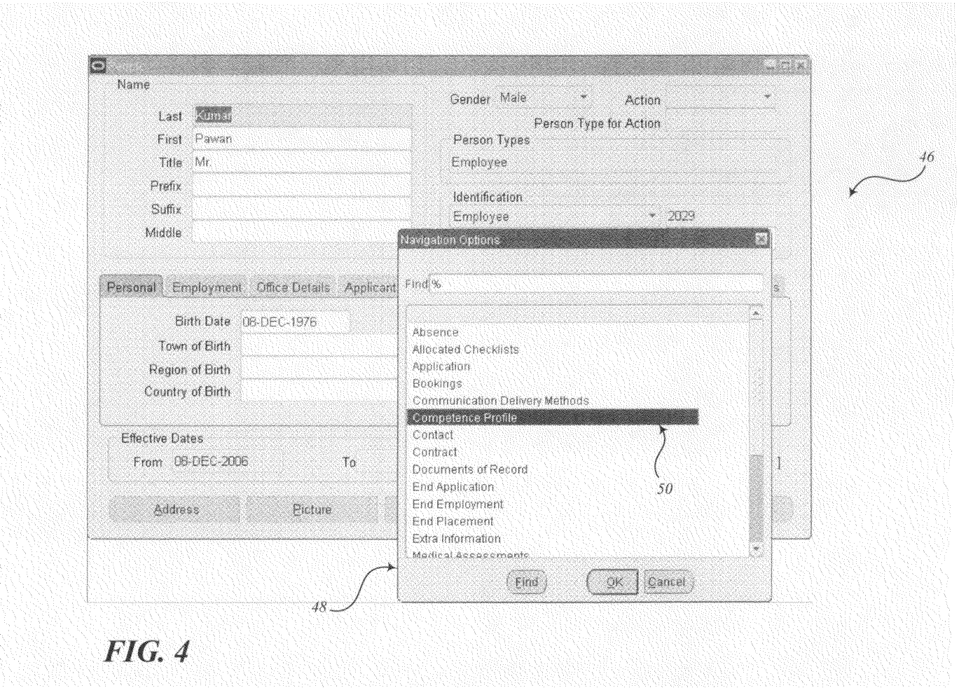

FIGS. 3-5 show GUIs related to setting up information about a person and the competencies that the person has. FIG. 3 is an embodiment of a GUI 42 allowing a user to enter and/or edit personnel information. GUI 42 may be associated with a human resources database. In conjunction with individual competence setup module 34 shown in FIG. 2, GUI 42 can be used to initially enter or edit existing information about an employee in a corporation's databases. From GUI 42, the user can bring up a Navigation Options window as shown in FIG. 4. For example, such a window can be accessed by clicking the Others button 44.

FIG. 4 is an embodiment of a GUI 46 showing a Navigation Options window 48 overlapping the screen shown in FIG. 3. One option in Navigation Options window 48, for example, includes a Competence Profile selection 50 allowing a user to select a competence profile of the employee whose personal information has already been entered in the corporation's databases.

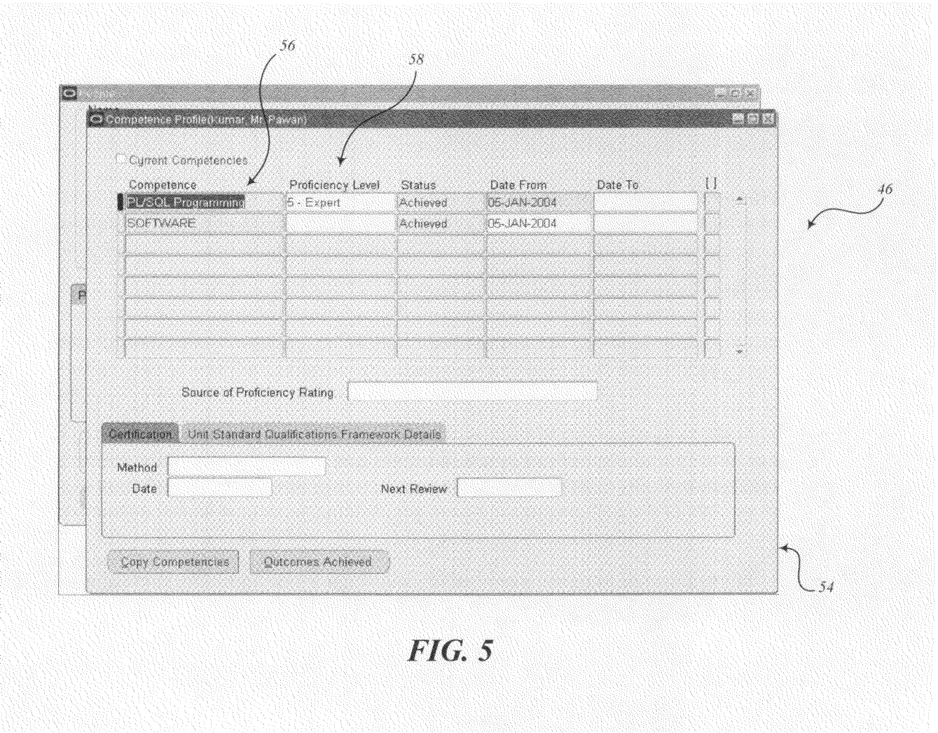

FIG. 5 is an embodiment of a GUI 52 showing a Competence Profile window 54 of the employee. From window 54, a user can enter and/or edit profile information concerning the employee's competence in one or more areas. Specific competences are entered under the Competence column 56. For example, concerning sensitive material handling, an operator may have competence regarding certain materials, handling operations, etc. With regard to each competence, a proficiency level may be entered in the Proficiency Level column 58. In some embodiments, the proficiency level may have default values from 1 to 5, where 5 is an expert proficiency. However, in other embodiments, the levels of proficiency can be defined using any system of number or characters depending on the desired setup.

Information is entered in the Competence column 56 and Proficiency Level column 58 based on the competencies that the particular individual already possesses. Different competencies can be based on acquiring certain degrees from colleges or universities, specialty studies, certification courses, etc. As an example, a person competent to dispense certain materials may have certification or training on how to handle materials, include such skills as how a material should be picked up, how it should be unpacked, protective gear to be used when handling the material, etc. Also, the person may be given training with respect to the consequences when the specific handling techniques are not followed.

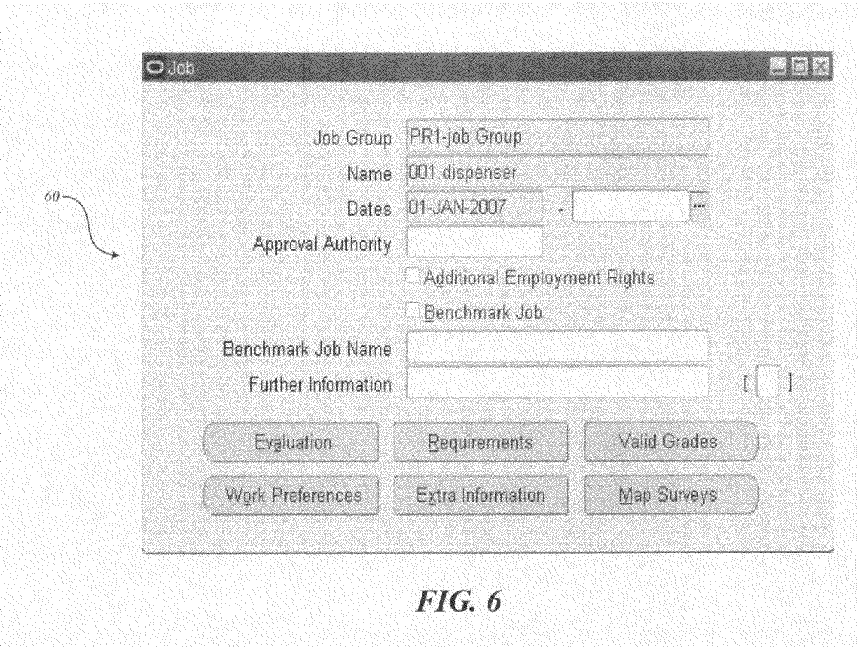

Referring again to FIG. 2, job/position defining module 36 allows a user to enter and/or edit job, position, or role information. In conjunction with job/position defining module 36 shown in FIG. 2, FIGS. 6-9 illustrate GUIs for setting up or establishing definitions of particular jobs, positions, roles, and related competencies for operations to be performed in the manufacturing process. GUI 60 of FIG. 6 illustrates a way in which the user can enter or edit generic or specific jobs or roles within the organization, enterprise, manufacturing company, etc. As illustrated in GUI 60, a job Name can be linked to a Job Group, such as a business group. Any other information for defining the jobs can be added as necessary.

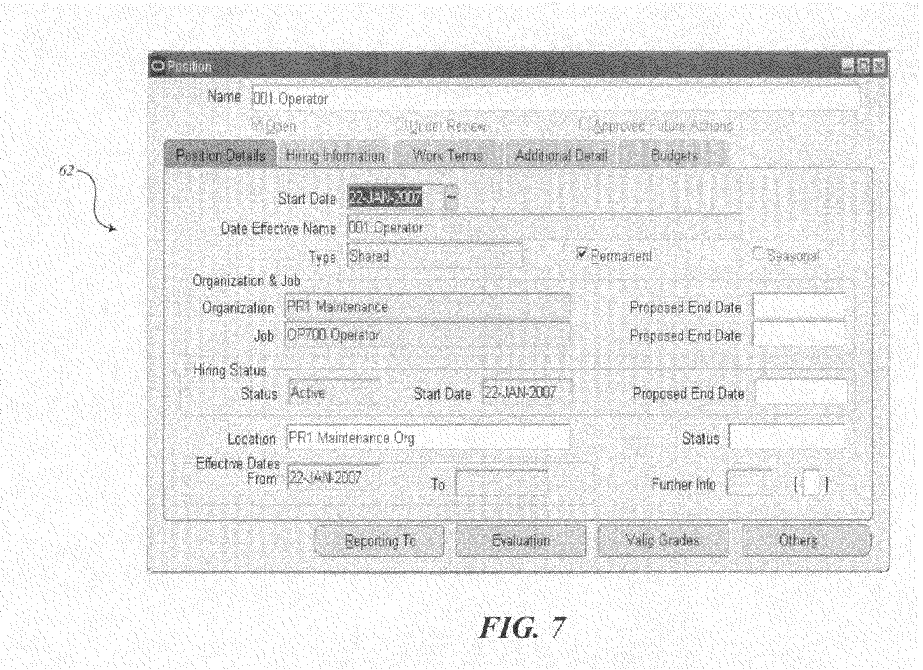

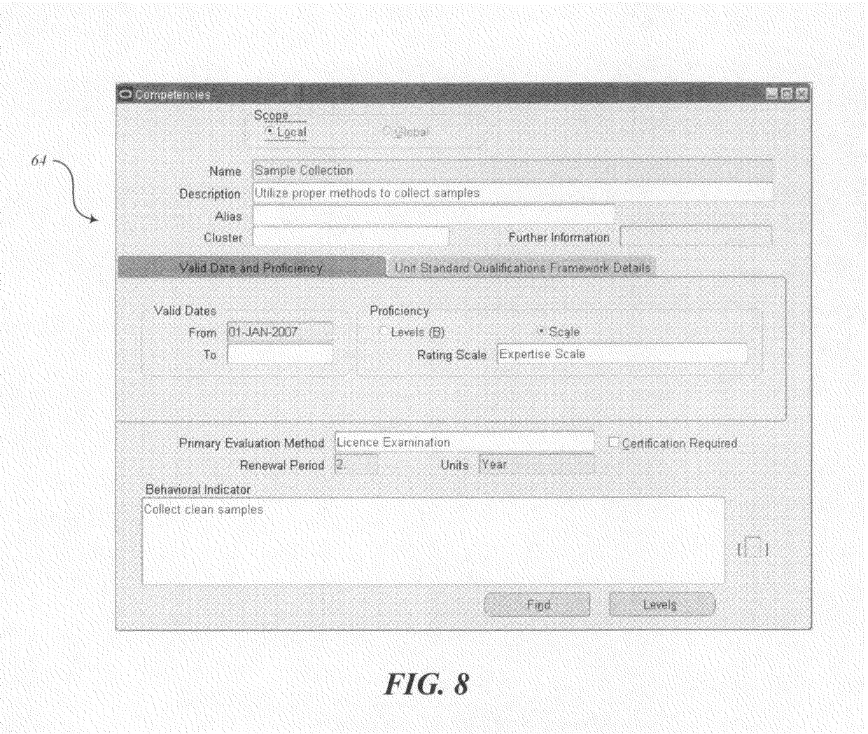

As shown in FIG. 7, GUI 62 allows the user to enter or edit details about positions as defined in a human resources system of the organization. In this example, a position called “Operator” is defined. From GUI 62, a user can select a Competencies screen to define the competencies associated with the respective position, as discussed further in FIG. 8. GUI 64 of FIG. 8 illustrates a Competencies screen that allows the user to enter or edit information related to various competence levels for respective position or jobs. In this example, a competence named “Sample Collection” is described as the ability to “utilize proper methods to collect samples”. Such a competence, for example, may be associated with a position or job that requires this particular competence. The jobs, positions, and competences are defined based on the type of manufacturing processes and needs of the organization. In some embodiments, similar types of competences can be grouped together. The competences, in some cases, can be associated with different types of jobs, positions, or roles.

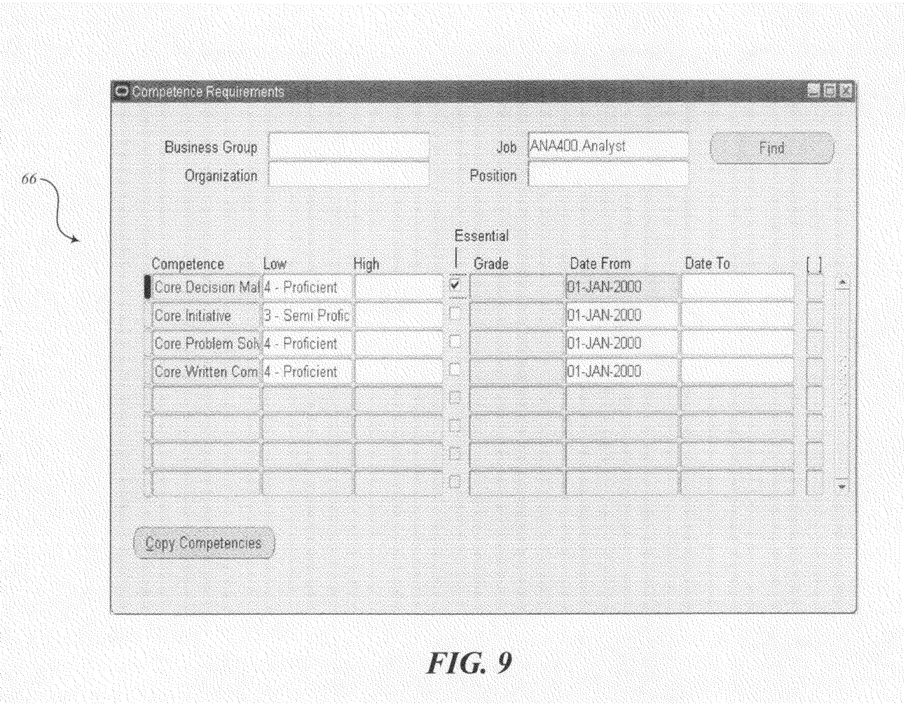

In FIG. 9, GUI 66 allows the user to enter or edit information pertaining to the relationship between competence/proficiency levels and the assigned jobs or positions of the corporation. The competence requirements can be defined based on the respective job or position. Once a manufacturing facility defines the types of competencies required at various manufacturing stages of the process, the organization might hire people based on their respective competencies. Some competencies may be optional and some may be mandatory, depending on the needs of the organization and/or the regulations set for manufacturing companies.

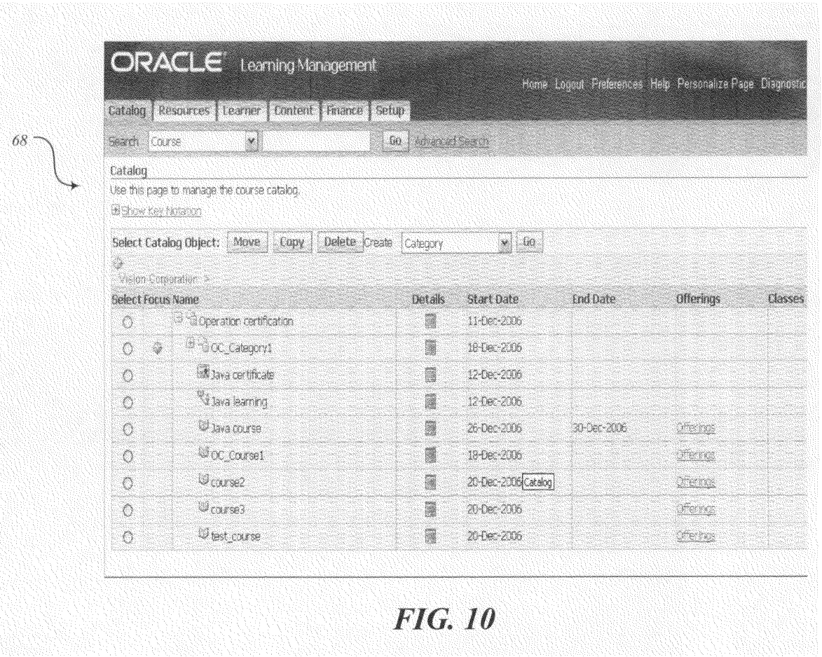

Referring again to FIG. 2, training/education assignment module 38 allows a user to define training and education course offerings and classes and to assign classes to operators or jobs depending on need. In conjunction with training/education assignment module 38, FIGS. 10-13 illustrate GUIs for managing course and certification information based on competencies that each operator has. FIG. 10 shows a GUI 68 configured to allow a user to maintain a catalog of the courses, offerings, classes, learning paths, etc., of a particular business group or job group. Some courses may be beneficial to some or all jobs within the job group or may pertain to a single job within the group. A course can be defined by attributes such as objectives and learner competence. The entity defines and describes the learning without specifics of content and delivery mode, which can be defined in the offering. Each course can have its own configurable information, which can define the dates that the courses are available, notification information regarding who is informed about the offerings, how frequently someone with a particular job or position should take the courses, etc.

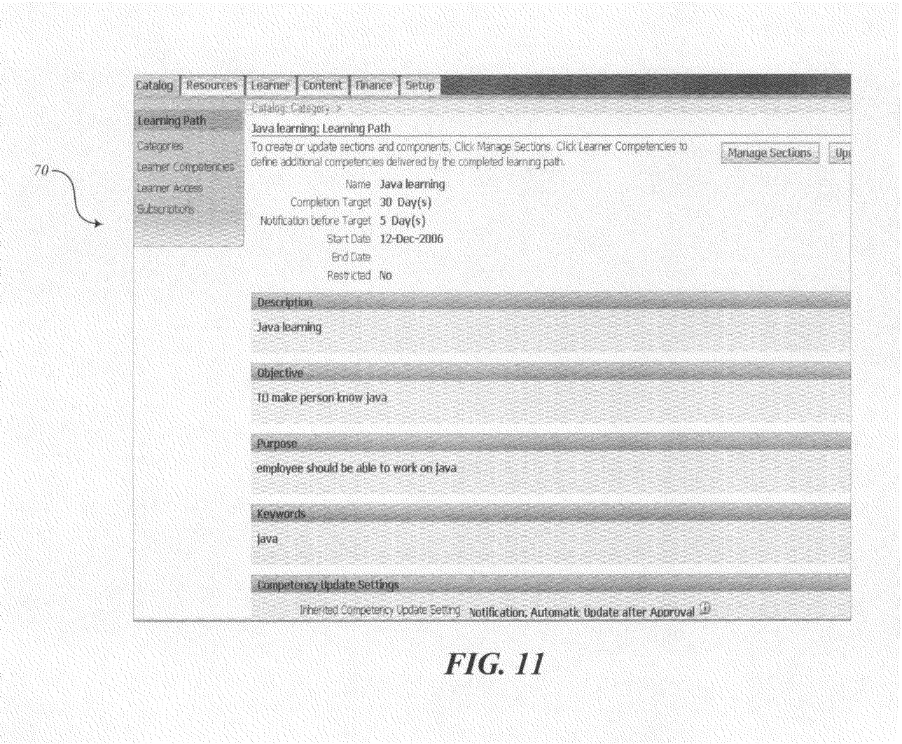

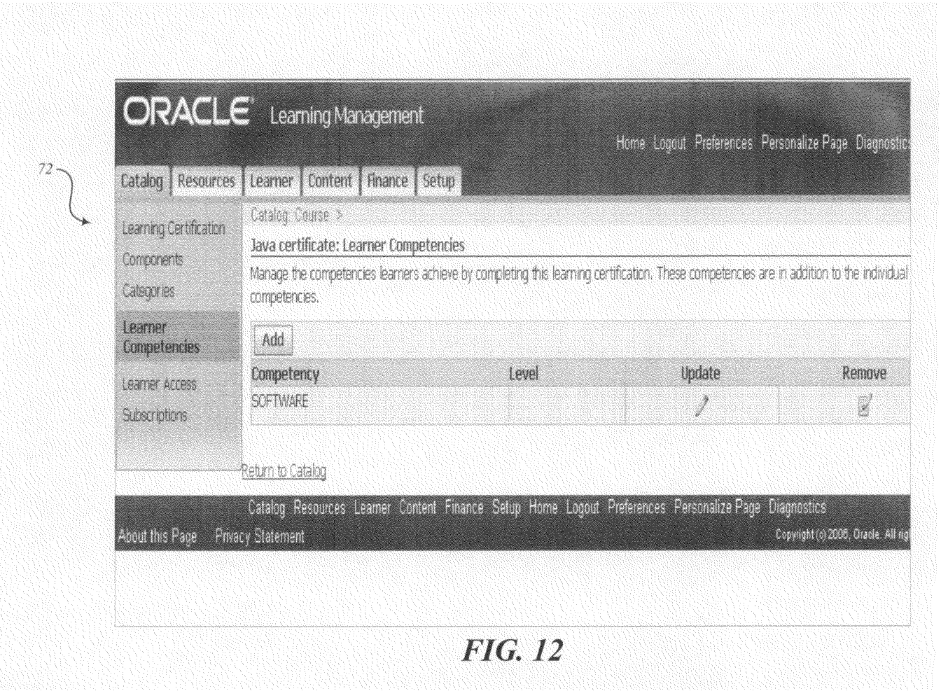

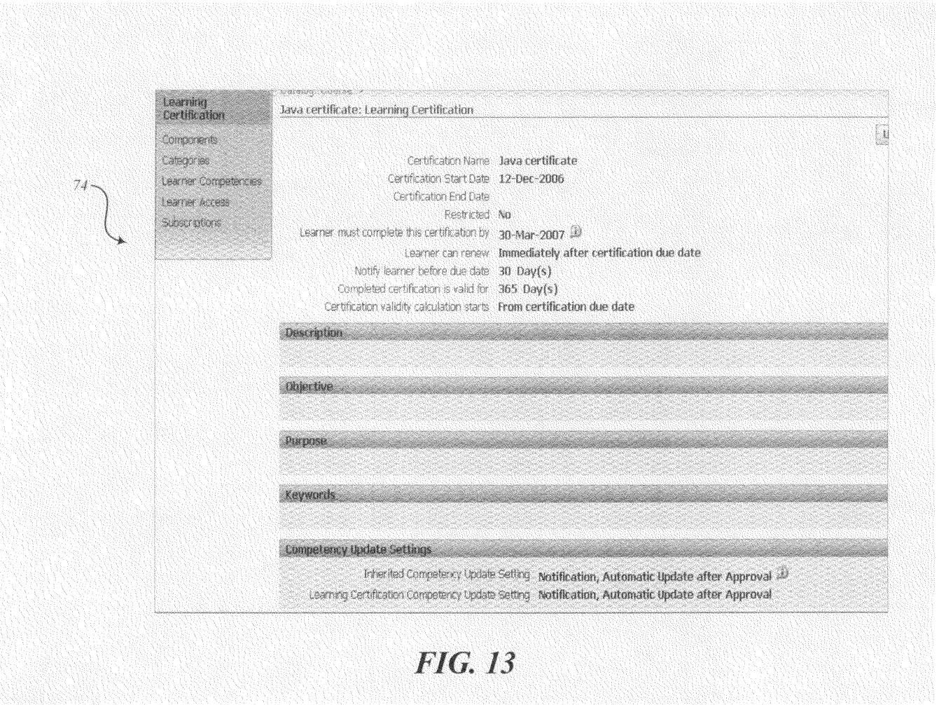

FIG. 11 shows a GUI 70 configured to allow a user to define a learning path and related competences and to access and update settings. A learning path is a sequence of two or more courses that enables tracking of a learner's progress. Different competences can be attached to a learning path. In FIG. 12, a GUI 72 allows a user to manage the competences that the learner achieves by completing the particular course or certification. The user can also identify and define certification requirements and renewal notifications. The competences can therefore be added to the individual's competence and stored in the competence profile in window 54 shown in FIG. 5 either manually or automatically. FIG. 13 illustrates a GUI 74 showing a certification notification that can be presented to the operator for taking a particular course. From the certification screen, the learner can be given the opportunity to subscribe to and complete one-time or renewable certifications. The learning certification includes a logical grouping of existing courses with added attributes, such as renewability, deadlines, etc.

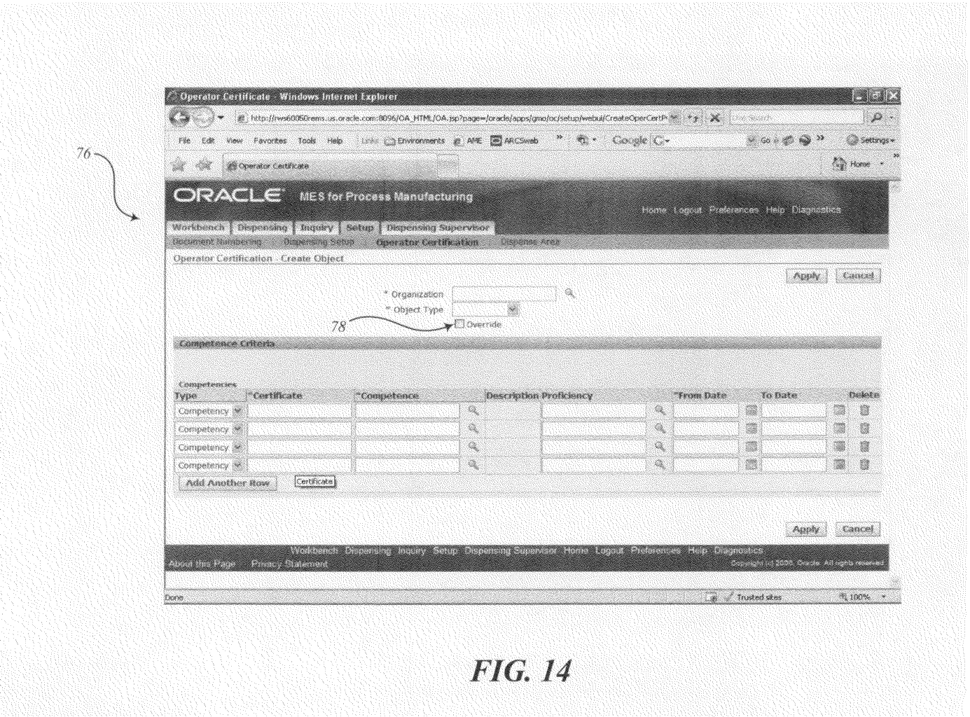

Referring again to FIG. 2, competence/override defining module 40 allows a user to setup competence requirements and process override conditions. In conjunction with competence/override defining module 40, FIGS. 14-16 show setup and actual operation notifications regarding competence and overrides.

FIG. 14 illustrates a GUI 76 that allows a user to set up or establish particular competence or certification requirements for certain actions, operations, tasks, transactions, items, resources, objects, etc. In this example, a task called “Create Object” is defined. This task may include one or more stages along the manufacturing process for creating an object. In order for this task to be performed, GUI 76 allows the user to list the proper competency or certification criteria that the operator needs to have to perform the task. Once the competency requirements are set up, an action or task can take place when it is determined that the operator contains the adequate competencies. In GUI 76, an override box 78 is included, allowing the user to specify whether the competency verification at the particular manufacturing stage can be overridden. When checked, then an override of the verification can be done. If not checked for this task or transaction, no one can override the verification process.

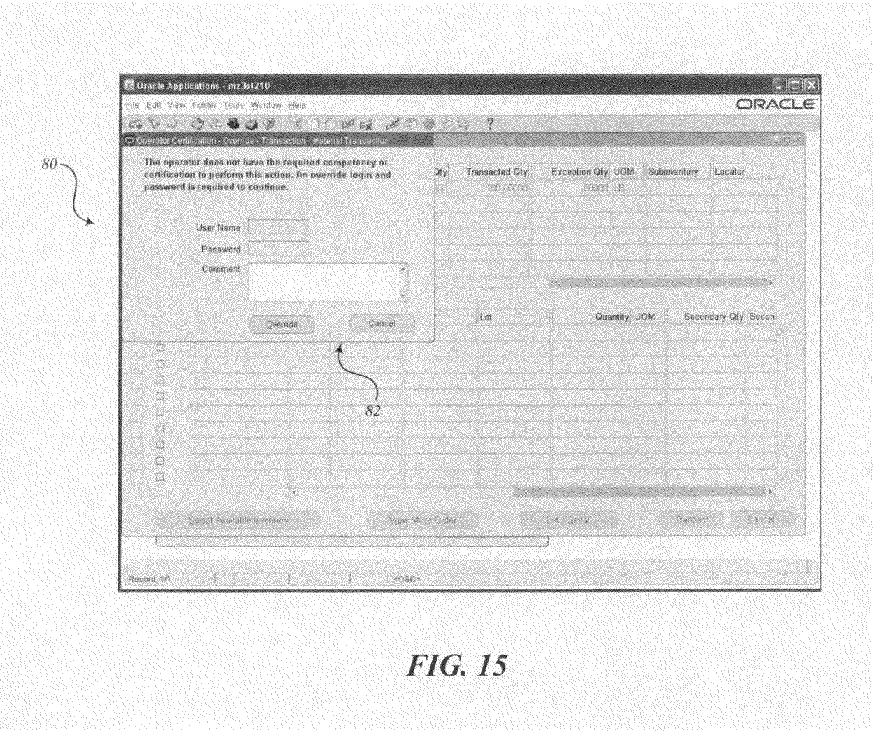

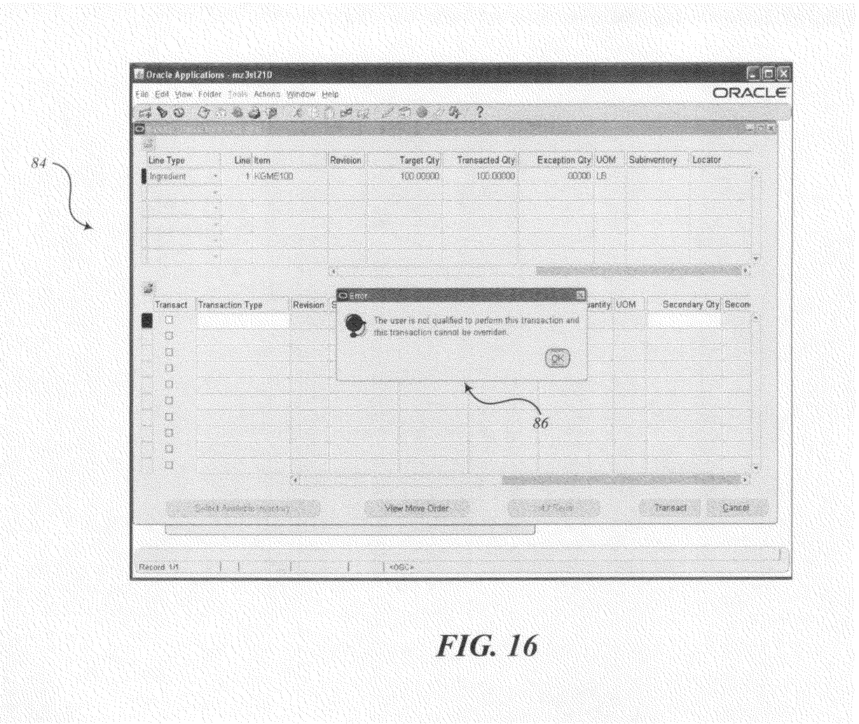

FIG. 15 illustrates a GUI 80 showing a stage of the manufacturing process. In this example, a situation occurs at the stage in which the operator does not have adequate competence to perform the action at that stage. When this happens, and an override has been allowed at this stage, window 82 is displayed. Window 82 provides a screen that allows a supervisor or other operator to enter login and password information for requesting to override the competence check at that stage. In order for an operator, e.g., a supervisor, to override a transaction, the operator enters a user name and password. With the proper entry in window 82, an override can be accomplished and the transaction can take place. If, however, override of the particular transaction is not allowed, GUI 84 of FIG. 16 is presented with an error indication window 86 to inform the requester that the operator is not competent or certified to perform the transaction and the transaction at that particular stage cannot be overridden.

It should be understood that the steps, processes, or operations described herein may represent any module or code sequence that can be implemented in software or firmware. In this regard, these modules and code sequences can include commands or instructions for executing specific logical steps, processes, or operations within physical components. It should further be understood that one or more of the steps, processes, and/or operations described herein may be executed substantially simultaneously or in a different order than explicitly described, as would be understood by one of ordinary skill in the art.

The embodiments described herein represent a number of implementations or examples and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

We claim:

1. A system for verifying the competence of an operator in a manufacturing facility, the system comprising:
one or more input/output (“I/O”) devices configured to receive information from a user and provide information to the user; and
a processing device configured to:
enable the user to set up a competence profile of an operator in the manufacturing facility;
enable the user to define jobs related to handling sensitive material at multiple material handling stages in the manufacturing facility;
assign training to the operator as needed to meet industry guidelines; and
enable the user to define competence levels required at each multiple material handling stage.

2. The system of claim 1, further comprising a memory device configured to store an operator competence verification program that is executable by the processing device.

3. The system of claim 2, wherein the memory device is further configured to store information related to education received by the operator, training received by the operator, and the experience level of the operator.

4. The system of claim 1, further comprising a network interface configured to be in communication with an integration system of the organization.

5. The system of claim 4, wherein the integration system is an enterprise resource planning (“ERP”) system.

6. The system of claim 1, wherein the one or more I/O devices include one or more graphical user interfaces.

7. The system of claim 1, wherein the user is an administrator of the organization.

8. The system of claim 1, wherein the sensitive materials are pharmaceutical materials and products.

9. The system of claim 1, wherein the sensitive materials are one of food products, hazardous materials, and precious materials.

10. The system of claim 1, wherein the processing device is configured to derive the competence profile from education, training, and experience information of the operator.

11. The system of claim 10, wherein the education, training, and experience information is associated with one or more tasks involved with handling the sensitive materials.

12. The system of claim 1, wherein the processing device is further configured to enable the user to set up competence profiles for a plurality of operators.

13. The system of claim 1, wherein the processing device is further configured to enable the user to set up an override of the competence level requirements at one or more material handling stages.

14. The system of claim 13, wherein the processing device is further configured to allow an override of the competence level requirement when an override has been set up at the respective material handling stage and when a supervisor of the operator is authorized to perform the override.

15. The system of claim 1, wherein the processing device is further configured to allow the operator to perform a task at a respective material handling stage when the competence profile of the operator satisfies the competence level at the respective material handling stage.

16. The system of claim 1, wherein the one or more I/O devices comprises a mechanism for displaying competence level checks and overrides at the various material handling stages.

17. A computer program stored on a computer-readable medium and executable by a processing device, the computer program comprising:
logic adapted to enable a user to enter education, training, and experience parameters with respect to one or more operators of a manufacturing facility to establish a competence profile of each operator;
logic adapted to enable the user to define jobs associated with handling sensitive material;
logic adapted to assign training or education to the one or more employees as needed; and
logic adapted to enable the user to define competence levels required at one or more locations where the sensitive material is handled.

18. The computer program of claim 17, further comprising logic adapted to verify the competence of each operator at each location where the sensitive material is handled.

19. The computer program of claim 18, wherein the logic adapted to verify competence is further adapted to compare the competence profile of each operator at each location with the competence level required at each respective location.

20. The computer program of claim 17, further comprising logic adapted to enable the user to set up override conditions allowing a supervisor of the respective operator to override one or more competence levels if needed.

21. A method comprising:
enabling an administrator of a manufacturing facility to set up a competence profile of one or more people who perform operations in the manufacturing facility;
enabling the administrator to define jobs related to handling sensitive material at multiple material handling stages in the manufacturing facility;
assigning training to the one or more people as needed to meet industry guidelines; and
enabling the administrator to define competence levels required at each multiple material handling stage.

22. The method of claim 21, further comprising receiving data entered by the administrator via one or more graphical user interfaces.

23. A system comprising:
means for enabling a user to enter education, training, and experience parameters with respect to one or more operators of a manufacturing facility in which sensitive material is handled;
means for establishing a competence profile of each operator based on the education, training, and experience parameters;
means for enabling the user to define competence levels required at one or more stages where the sensitive material is handled; and
means for assigning training or education to the one or more operators to meet the respective competence level requirements.

24. The system of claim 23, further comprising means for enabling the user to enter override information allowing the competence level requirement at one or more stages to be overridden.

25. The system of claim 23, further comprising means for graphically interfacing with the user to receive information related to the competence level requirements and education, training, and experience parameters.
